(19) United States
(12) Patent Application Publication
(10) Pub. No.: US 2012/0176978 A1
(43) Pub. Date: Jul. 12, 2012

(54) METHOD AND APPARATUS FOR COORDINATING BETWEEN CELLS IN WIRELESS COMMUNICATION SYSTEM

(75) Inventor: Yung-Soo KIM, Seongnam-si (KR)

(73) Assignee: SAMSUNG ELECTRONICS CO. LTD., Suwon-si (KR)

(21) Appl. No.: 13/346,957

(22) Filed: Jan. 10, 2012

(30) Foreign Application Priority Data
Jan. 12, 2011 (KR) 10-2011-0003031

(51) Int. Cl. H04W 74/04; H04W 72/04

(52) U.S. Cl. 370/329

(57) ABSTRACT

A method and an apparatus for inter-cell coordination in a wireless communication system are provided. A method of a Base Station (BS) for the inter-cell coordination in the wireless communication system includes receiving information of a neighboring Mobile Station (MS) from a neighboring BS, receiving an UpLink (UL) control signal of the neighboring MS based on the received information of the neighboring MS, and performing inter-cell coordination for the neighboring MS using the received UL control signal.

### PRIORITY

This application claims the benefit under 35 U.S.C. §119(a) of a Korean patent application filed in the Korean Intellectual Property Office on Jan. 12, 2011 and assigned Serial No. 10-2011-0003031, the entire disclosure of which is hereby incorporated by reference.

### BACKGROUND OF THE INVENTION

1. Field of the Invention

The present invention relates to a wireless communication system. More particularly, the present invention relates to a method and an apparatus for coordinating between cells in the wireless communication system.

2. Description of the Related Art

When adjacent cells use the same frequency in a cellular communication environment, severe interference can occur in a cell boundary region. Hence, various methods are provided to mitigate inter-cell interference and to enhance capacity of the cell boundary in a wireless communication system of the cellular communication environment. For example, a Coordinated Multi-Point (CoMP) transmission and reception method for coordinating and communicating between the neighboring cells by taking account of an instantaneous channel value and a traffic condition of a mobile station traveling in the cell boundary is provided. More particularly, the CoMP method can be divided into a Coordinated Scheduling (CS)/Coordinated Beamforming (CB) method and a Joint Processing (JP) method. When a base station transmits a signal, the CS/CB method maximizes the signal strength of a serving mobile station through antenna beamforming and minimizes interference on the mobile station of the neighboring base station in the cell boundary. According to the JP method, a plurality of neighboring base stations transmits the same signal concurrently to the mobile station traveling in the cell boundary.

FIG. 1 illustrates inter-cell coordination in a wireless communication system according to the related art.

Referring to FIG. 1, when a Base Station 1 (BS1) 100 is a serving BS of a Mobile Station 1 (MS1) 110 and a BS2 102 is a serving BS of an MS2 112, the BS1 100 and the MS1 110 transmit and receive downlink and uplink user signals 151 and 152 and downlink and uplink control signals 153 and 154, and the BS2 102 and the MS2 112 transmit and receive downlink and uplink user signals 161 and 162 and downlink and uplink control signals 163 and 164.

Herein, for the CoMP operation coordinated between the cells, the BS1 100 and the BS2 102 exchange user data and instantaneous information of their MS via backhauls 141 and 142 connected to a radio access network. Herein, the instantaneous information indicates resource allocation information of the CoMP applied MS, Hybrid Automatic Repeat reQuest (HARQ) ACKnowledgement (ACK)/Negative ACKnowledgement (NACK) information of the MS for the previous downlink transmission, channel information of the neighboring coordination cell, and optimum antenna beamforming/precoding information. That is, the BS1 100 and the BS2 102 receive from their MS, channel values of the serving cell and the neighboring cell and feedback information indicating the ACK/NACK of the previous downlink transmission, and then exchange the instantaneous information including the feedback information with the neighboring BS over the backhaul.

Based on the exchanged information, the BS1 100 can transmit the user signal 151 to the MS1 110 to minimize the interference on the MS2 112 of the neighboring cell, or transmit the user signal 155 to the MS2 112 as transmitting the user signal 151 to the MS1 110. Likewise, the BS2 102 can transmit the user signal 161 to the MS2 112 to minimize the interference on the MS1 110 of the neighboring cell based on the exchanged information, or transmit the user signal 165 to the MS1 110 as transmitting the user signal 161 to the MS2 112. Herein, the user signal transmitted from the BS1 100 to the MS2 112 of the neighboring cell is the same as the user signal transmitted from the BS2 102 to the MS2 112, and the user signal transmitted from the BS2 102 to the MS1 110 of the neighboring cell is the same as the user signal transmitted from the BS1 100 to the MS1 110.

As described above, while the inter-cell coordination provided in the wireless communication system according to the related art can enhance the cell boundary and cell average capacities, it is necessary to exchange a large amount of the user data and the instantaneous information between the BSs. Thus, a delay can be caused. More particularly, a 3rd Generation Partnership Project (3GPP) Long Term Evolution (LTE) system uses an X2 interface for the information exchange between the BSs. The X2 interface can require several milliseconds to tens of milliseconds according to the backhaul condition and the backhaul protocol type, and accordingly more time delay can occur in the exchange of the instantaneous information. As the information exchange between the BSs is delayed, the channel variation according to the movement of the corresponding MS can increase. As a result, the performance of the CoMP method is degraded and the travel speed of the MS to apply the CoMP method is quite limited. When the CoMP method is applied to a HARQ retransmit signal, it is necessary for the BSs to exchange the ACK/NACK information transmitted from the MS. In so doing, in a service sensitive to the delay, such as Voice over Internet Protocol (VoIP), the HARQ retransmission can be infeasible because of the information exchange delay between the BSs.

Therefore, a need exists for a method for addressing the performance degradation of the CoMP because of the information exchange delay between the BSs.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for coordinating between cells in a wireless communication system.

Another aspect of the present invention is to provide a method and an apparatus for coordinating between cells by directly receiving an UpLink (UL) control signal of a Mobile Station (MS) at a serving Base Station (BS) and a neighboring BS in a wireless communication system.

Yet another aspect of the present invention is to provide a method and an apparatus for a serving BS to transmit resource allocation information of its MS to a neighboring BS and for the neighboring BS to receive a control signal from the MS of the serving BS in a wireless communication system.

According to one aspect of the present invention, a method of a BS for inter-cell coordination in a wireless communication system is provided. The system includes receiving information of a neighboring MS from a neighboring BS, receiving a UL control signal of the neighboring MS based on the received information of the neighboring MS, and performing inter-cell coordination for the neighboring MS using the received UL control signal.

According to another aspect of the present invention, an apparatus of a BS for inter-cell coordination in a wireless communication system is provided. The apparatus includes a backhaul communication unit for receiving information of a neighboring MS from a neighboring BS, a transceiver for receiving a UL control signal of the neighboring MS based on the received information of the neighboring MS, and a controller for controlling to perform inter-cell coordination for the neighboring MS using the received UL control signal.

According to yet another aspect of the present invention, a method of an MS for inter-cell coordination in a wireless communication system is provided. The system includes receiving resource allocation information from a serving BS, and transmitting a UL control signal to the serving BS. The UL control signal is received by a neighboring BS according to information exchanged in advance by the serving BS and the neighboring BS over a backhaul.

According to still another aspect of the present invention, an apparatus of an MS for inter-cell coordination in a wireless communication system is provided. The system includes a transceiver for transmitting and receiving signals, and a controller for controlling the transceiver to receive resource allocation information from a serving BS, and to transmit a UL control signal to the serving BS. The UL control signal is received by a neighboring BS according to information exchanged in advance by the serving BS and the neighboring BS over a backhaul.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates inter-cell coordination in a wireless communication system according to the related art;

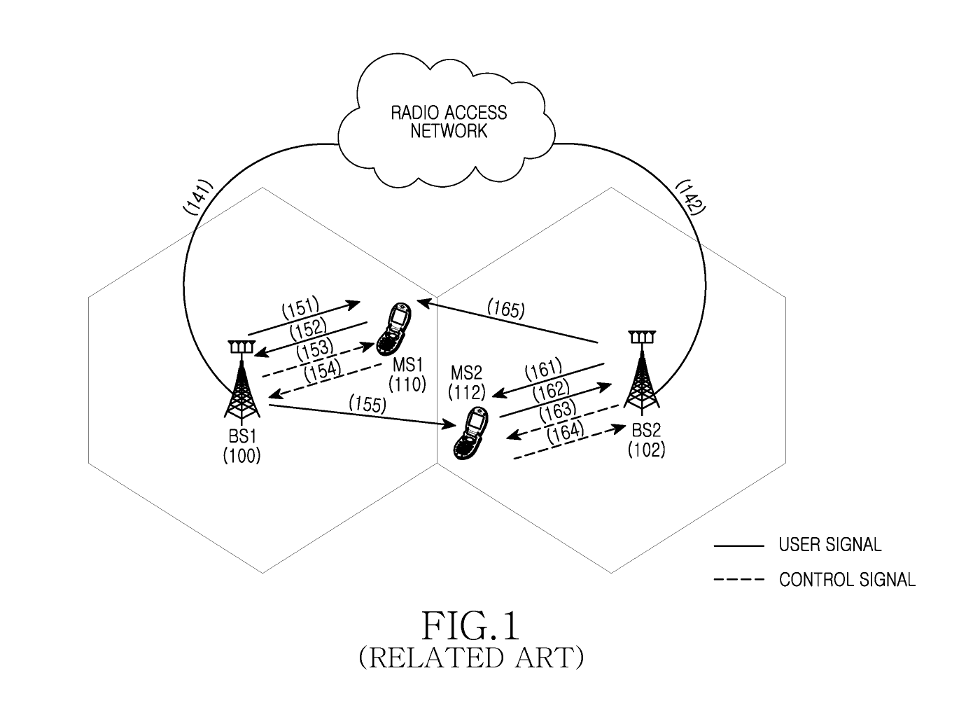

FIG. 2 illustrates inter-cell coordination in a wireless communication system according to an exemplary embodiment of the present invention;

FIG. 3 illustrates signal sequences for a Coordinated Scheduling (CS)/Coordinated Beamforming (CB) scheme in a wireless communication system according to an exemplary embodiment of the present invention;

FIG. 4 illustrates signal sequences for a Joint Processing (JP) scheme in a wireless communication system according to an exemplary embodiment of the present invention;

FIG. 5 illustrates a base station in a wireless communication system according to an exemplary embodiment of the present invention;

FIG. 6 illustrates operations of a base station in a wireless communication system according to an exemplary embodiment of the present invention; and

FIG. 7 illustrates a mobile station in a wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a method and an apparatus for inter-cell coordination in a wireless communication system. Hereinafter, while two neighboring cells are exemplified to ease the understanding, the present invention is equally applicable to three or more neighboring cells.

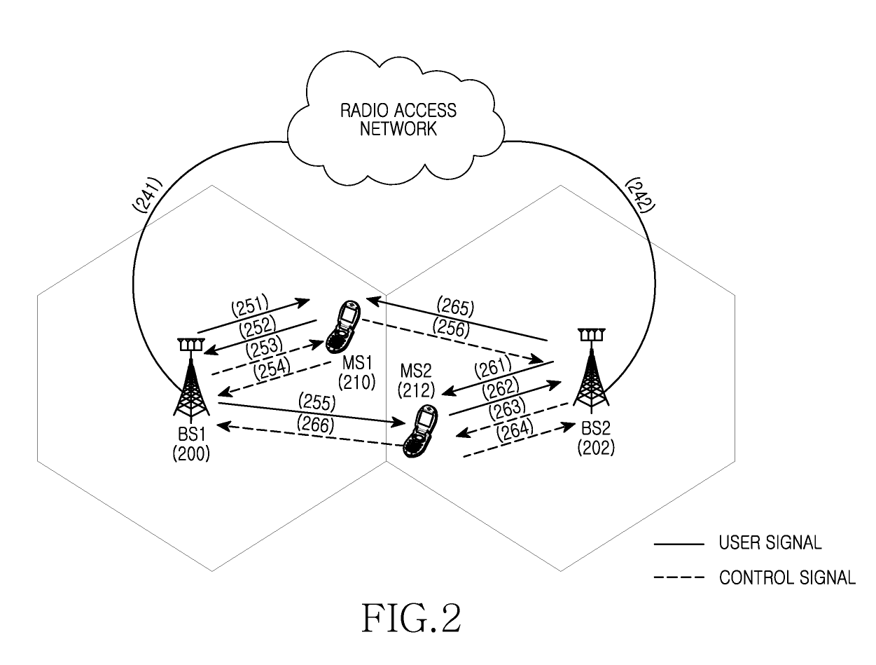

FIG. 2 illustrates inter-cell coordination in a wireless communication system according to an exemplary embodiment of the present invention.

Referring to FIG. 2, when a Base Station 1 (BS1) 200 is a serving BS of a Mobile Station 1 (MS1) 210 and a BS2 202 is a serving BS of an MS2 212, the BS1 200 and the MS1 210 transmit and receive DownLink (DL) and UpLink (UL) user signals 251 and 252 and DL and UL control signals 253 and 254, and the BS2 202 and the MS2 212 transmit and receive DL and UL user signals 261 and 262 and DL and UL control signals 263 and 264.

The BS1 200 determines whether to apply a Coordinated Multi-Point (CoMP) scheme by receiving channel information 254 from its MS1 210. Upon determining to apply the CoMP scheme, the BS1 200 allocates UL and DL resources for the MS1 210 and then transmits to the BS2 202, resource allocation information of the MS1 210 and information for receiving and processing the control signal transmitted from the MS1 210 via backhauls 241 and 242. The BS1 200 receives the resource allocation information of the MS2 212 and information for receiving and processing the control signal transmitted from the MS2 212, from the BS2 202 over the backhaul 241 and 242. Hence, the BS1 200 can receive the channel information 254 from the MS1 210, and receive channel information 266 transmitted from the MS2 212 and the BS2 202 based on the information received from the BS2 202. Herein, while the signal 266 is the same as the signal 264 transmitted from the MS2 212 to the BS2 202, it is depicted to illustrate that the signal transmitted from the MS2 212 to the BS2 202 is received at the BS1 200. Herein, it is noted that the BS1 200 receiving the signal of the MS2 212 does not affect the communication of the MS2 212 and the BS2 202 at all.

According to the preset inter-cell coordination scheme, the BS1 200 transmits the signal to the MS1 210 or transmits the signal to the MS1 210 and the MS2 212. That is, when the preset inter-cell coordination is a Coordinated Scheduling (CS)/Coordinated Beamforming (CB) scheme, the BS1 200 can transmit the signal 251 to the MS1 210 using the information received from the MS1 210 and the information received from the MS2 212 according to the CS/CB scheme of the related art to minimize the interference on the MS2 212. When the preset inter-cell coordination is a Joint Processing (JP) scheme, the BS1 200 can transmit the signal 251 to the MS1 210 and the signal 256 to the MS2 212 using the information received from the MS1 210 and the information received from the MS2 212 according to the JP scheme of the related art. Herein, the signal transmitted from the BS1 200 to the MS2 212 of the neighboring cell is the same as the signal transmitted from the BS2 202 to the MS2 212.

Similarly to the BS1 200, the BS2 202 determines whether to apply the CoMP scheme by receiving the channel information from its MS2 212. Upon determining to apply the CoMP scheme, the BS2 202 allocates the UL and DL resources to the MS2 212, and then transmits the resource allocation information of the MS2 212 and the information for receiving and processing the control signal from the MS2 212, to the BS1 200 over the backhauls 241 and 242. The BS2 202 receives the resource allocation information of the MS1 210 and the information for receiving and processing the control signal from the MS1 210, from the BS1 200 over the backhauls 241 and 242. Hence, the BS2 202 can receive the channel information 264 from the MS2 212, and receive the channel information transmitted from the MS1 210 to the BS1 200 based on the information received from the BS1 200. Herein, while the signal 256 is the same as the signal 254 transmitted from the MS1 210 to the BS1 200, it is depicted to indicate that the BS2 202 receives the signal transmitted from the MS1 210 to the BS1 200. Herein, the BS2 202 receiving the signal of the MS1 210 does not affect the communication of the MS1 210 and the BS1 200 at all.

The BS2 202 transmits the signal to the MS2 212 or transmits the signal to the MS2 212 and the MS1 210 according to the preset inter-cell coordination scheme. That is, when the preset inter-cell coordination is the CS/CB scheme, the BS2 202 can transmit the signal 261 to the MS2 212 using the information received from the MS2 212 and the information received from the MS1 210 according to the CS/CB scheme of the related art to minimize the interference on the MS1 210. When the preset inter-cell coordination is the JP scheme, the BS2 202 can transmit the signal 261 to the MS2 212 and the signal 265 to the MS1 210 using the information received from the MS2 212 and the information received from the MS1 210 according to the JP scheme of the related art. Herein, the signal transmitted from the BS2 202 to the MS1 210 of the neighboring cell is the same as the signal transmitted from the BS1 200 to the MS1 210.

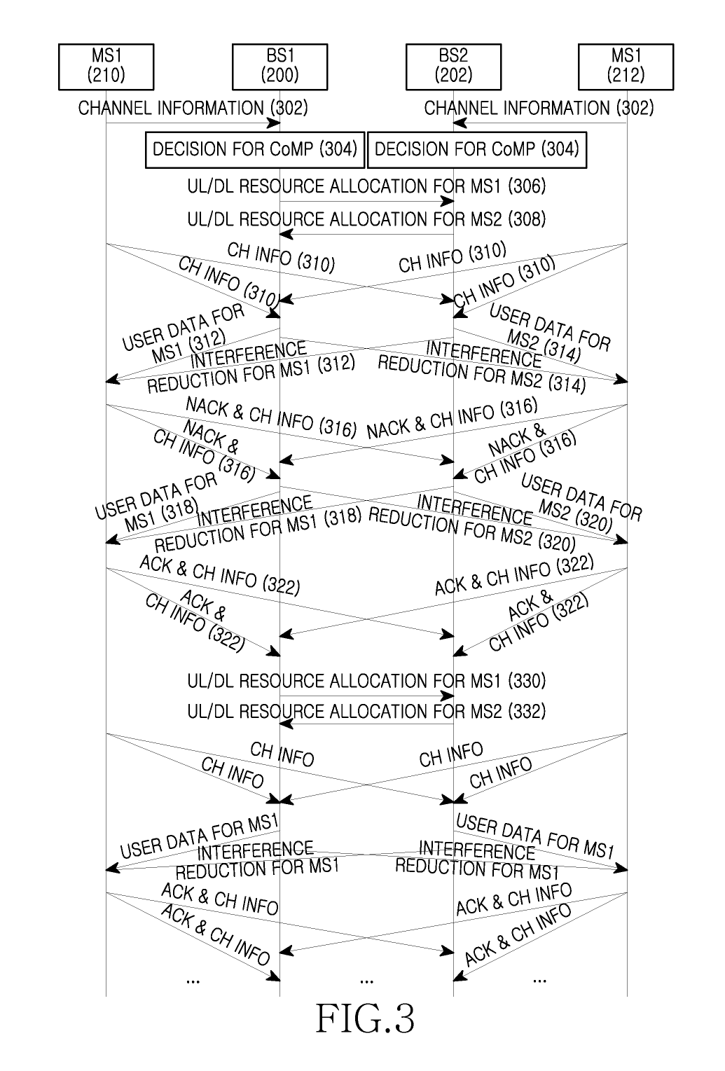

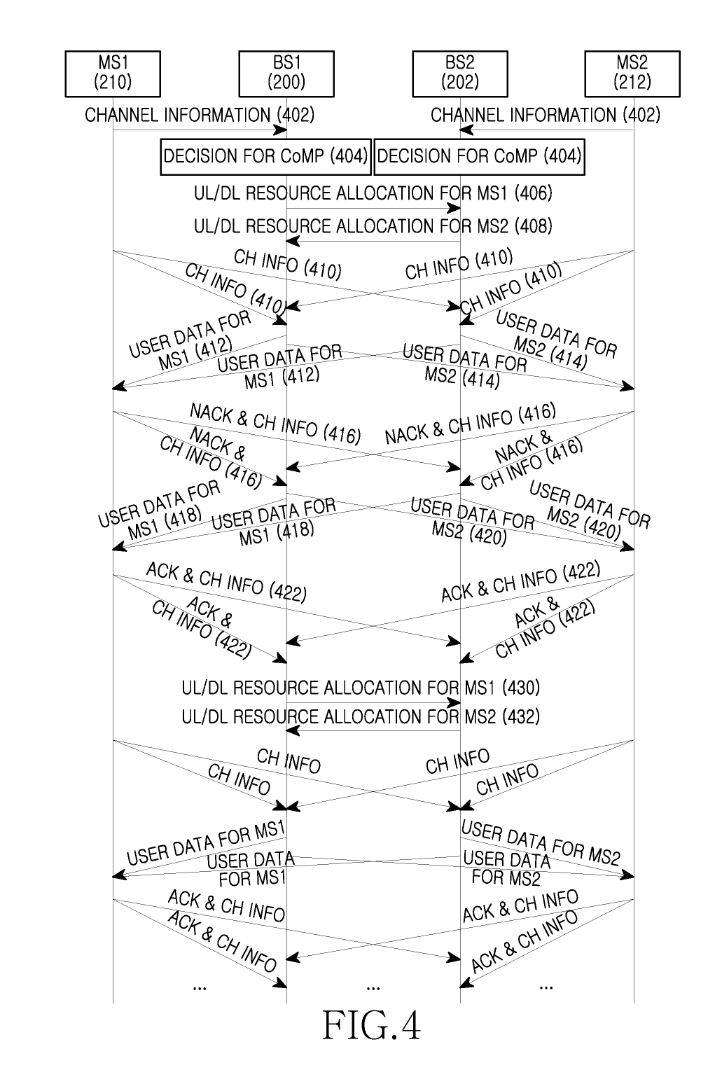

Now, based on the above descriptions, the CS/CB scheme and the JP scheme are illustrated by referencing FIGS. 3 and 4.

FIG. 3 is a signal sequence diagram of the CS/CB scheme in a wireless communication system according to an exemplary embodiment of the present invention. Herein, the BS1 200 and the BS2 202 are the BSs of the neighboring cells, the BS1 200 is the serving BS of the MS1 210, and the BS2 202 is the serving BS of the MS2 212.

Referring to FIG. 3, the MS1 210 and the MS2 212 transmit a control signal including channel information to their serving BS1 200 and BS2 202 in step 302. Herein, the control signal includes the channel information of the serving BS and the channel information of the neighboring BS. The channel information can include channel state information of every antenna combination, a channel quality indicator, a precoding matrix indicator, a rank indicator, an antenna codebook, an optimal antenna weight or code value of the serving BS, and an antenna weight or code value not to be selected by the neighboring BS. According to Time Division Duplex (TDD), the channel information can include a sounding signal.

The BS1 200 and the BS2 202 receiving the channel information from their service MS (hereinafter, referred to as a serving MS) determine whether to apply a CoMP scheme to the serving MS in step 304. Whether to apply the CoMP scheme to the serving MS can be determined by obtaining Reference Signal Received Power (RSRP) and Signal to Interference and Noise Ratio (SINR) information of the serving BS of the corresponding MS and RSRP and SINR information of the neighboring BS from the received channel information, and determining whether the MS travels in the cell boundary area. Notably, whether to apply the CoMP scheme can be determined in various conventional manners.

Upon determining to apply the CoMP scheme to the MS, the BS1 200 and the BS2 202 allocate UL and DL resources to their serving MSs 210 and 212 and exchange the resource allocation information of their serving MSs 210 and 212 and the information for receiving and processing the control signal from their serving MSs 210 and 212 over backhauls in steps 306 and 308. Herein, the information for receiving and processing the control signal from the MS includes a scrambling sequence of the signal, a hopping pattern, IDentifier (ID) information of the BS and the MS, and Modulation and Coding Scheme (MCS) information.

When the MS1 210 and the MS2 212 transmit the signal including the channel information in step 310, the BS1 200 and the BS2 202 can receive not only the channel information from their serving MS but also the channel information from the serving MS (hereinafter, referred to as a neighboring MS) of the neighboring BS using the information exchanged in steps 306 and 308. The MSs 210 and 212 transmit the channel information to both of the BS1 200 and the BS 202 in FIG. 3. Actually, the MS1 210 transmits the channel information to the BS1 200, the MS2 212 transmits the channel information to the BS2 202, and the BSs 200 and 202 receive the channel information from the neighboring MS using the information exchanged over the backhaul. Herein, the BSs receiving the signal from the neighboring MS do not affect the communication between the serving MS of the neighboring BS and the neighboring BS at all. Since the BSs 200 and 202 receive the control signals from not only its serving MS but also the neighboring MS, other network components are unnecessary and each BS can determine and apply an algorithm for the CoMP scheme to the signal transmission immediately. For example, the BSs 200 and 202 can determine the antenna value based on the control signals received from their serving MS and neighboring MS and apply the antenna value to the next transmit signal for the serving MS.

The BSs 200 and 202 transmit the user data to their serving MSs 210 and 212 while minimizing the interference of the neighboring MS through the scheduling and the beamforming in steps 312 and 314. When the BS1 200 transmits the user data to the serving MS1 210 in step 312, the BS2 202 can minimize the interference on the MS1 210 through the scheduling and the beamforming When the BS2 202 transmits the user data to the serving MS2 212 in step 314, the BS1 200 can minimize the interference on the MS2 212 through the scheduling and the beamforming.

The MSs 210 and 212 receiving the user data from their serving BS transmit ACKnowledgement (ACK)/Negative ACKnowledgement (NACK) information and the channel information to their serving BS in steps 316 and 322. Herein, when the MSs 210 and 212 transmit the NACK information of the previous user data and the channel information in step 316, the BSs 200 and 202 minimize interference to the serving MS of the neighboring BS through the scheduling and the beamforming, and retransmit the previous user data to their serving MSs 210 and 212 in steps 318 and 320. In so doing, the resource for the DL retransmission to the MSs 210 and 212 may be allocated when the corresponding serving BS allocates an initial resource, or may be allocated by the corresponding serving BS upon receiving the NACK. Herein, when the serving BS upon receiving the NACK allocates the resource for the retransmission, it is necessary to transmit the allocation information of the retransmission resource to the neighboring BS.

In contrast, when the MSs 210 and 212 transmit the ACK and the channel information in step 322, the BSs 200 and 202 exchange the resource allocation information for the next DL data transmission with the neighboring BS in steps 330 and 332 and thus repeat steps 310 through 322. A resource allocation information exchange cycle between the serving BS of the MS and the neighboring BS can vary according to the design.

FIG. 4 a signal sequence diagram of a JP scheme in a wireless communication system according to an exemplary embodiment of the present invention. As in FIG. 3, the BS1 200 and the BS2 202 are the BSs of the neighboring cells, the BS1 200 is the serving BS of the MS1 210, and the BS2 202 is the serving BS of the MS2 212.

Referring to FIG. 4, the MS1 210 and the MS2 212 transmit the control signal including channel information to their serving BS1 200 and BS2 202 in step 402. Herein, the control signal includes the channel information of the serving BS and the channel information of the neighboring BS. The channel information can include a channel state information of every antenna combination, a channel quality indicator, a precoding matrix indicator, a rank indicator, an antenna codebook, an optimal antenna weight or code value of the serving BS, and an antenna weight or code value not to be selected by the neighboring BS. According to TDD, the channel information can include a sounding signal.

The BS1 200 and the BS2 202 receiving the channel information from their service MS (hereinafter, referred to as the serving MS) determine whether to apply a CoMP scheme to the serving MS in step 404. Whether to apply the CoMP scheme to the serving MS can be determined by obtaining the RSRP and SINR information of the serving BS of the corresponding MS and the RSRP and SINR information of the neighboring BS from the received channel information, and determining whether the MS travels in the cell boundary area. Notably, whether to apply the CoMP scheme can be determined in various conventional manners.

Upon determining to apply the CoMP scheme to the MS, the BS1 200 and the BS2 202 allocate UL and DL resources to their serving MSs 210 and 212 and exchange the resource allocation information of their serving MSs 210 and 212 and the information for receiving and processing the control signal from their serving MSs 210 and 212 over backhauls in steps 406 and 408. Herein, the information for receiving and processing the control signal from the MS includes a scrambling sequence of the signal, a hopping pattern, ID information of the BS and the MS, and MCS information.

When the MS1 210 and the MS2 212 transmit the signal including the channel information in step 410, the BS1 200 and the BS2 202 can receive not only the channel information from their serving MS but also the channel information from the serving MS (hereinafter, referred to as the neighboring MS) of the neighboring BS using the information exchanged in steps 406 and 408. The MSs 210 and 212 transmit the channel information to both of the BS1 200 and the BS2 202 in FIG. 3. Actually, the MS1 210 transmits the channel information to the BS1 200, the MS2 212 transmits the channel information to the BS2 202, and the BSs 200 and 202 receive the channel information from the neighboring MS using the information exchanged over the backhaul. Herein, the BSs receiving the signal from the neighboring MS do not affect the communication between the serving MS of the neighboring BS and the neighboring BS at all. Since the BSs 200 and 202 receive the control signals from not only its serving MS but also the neighboring MS, other network components are unnecessary and each BS can determine and apply the algorithm for the CoMP scheme to the signal transmission immediately. For example, the BSs 200 and 202 can determine the antenna value based on the control signals received from their serving MS and neighboring MS and apply the antenna value to the next transmit signal for the serving MS.

The BSs 200 and 202 transmit the user data to their serving MS and the neighboring MS in steps 412 and 414. When the BS1 200 transmits the user data to the serving MS1 210 in step 412, the BS2 202 can also transmit the same user data to the MS1 210. When the BS2 202 transmits the user data to the serving MS2 212 in step 414, the BS1 200 can also transmit the same user data to the MS2 212.

The MSs 210 and 212 receiving the user data from their serving BS transmit ACK/NACK information and the channel information to their serving BS in steps 416 and 422. Herein, when the MSs 210 and 212 transmit the NACK information of the previous user data and the channel information in step 416, the BSs 200 and 202 minimize interference to the serving MS of the neighboring BS through the scheduling and the beamforming and retransmit the previous user data to their serving MSs 210 and 212 in steps 418 and 420. In so doing, the resource for the DL retransmission to the MSs 210 and 212 may be allocated when the corresponding serving BS allocates the initial resource, or may be allocated by the corresponding serving BS upon receiving the NACK. Herein, when the serving BS upon receiving the NACK allocates the resource for the retransmission, the allocation information of the retransmission resource should be provided to the neighboring BS.

In contrast, when the MSs 210 and 212 transmit the ACK and the channel information in step 422, the BSs 200 and 202 exchange the resource allocation information for the next DL data transmission with the neighboring BS in steps 430 and 432 and thus repeat steps 410 through 422. The resource allocation information exchange cycle between the serving BS of the MS and the neighboring BS can vary according to the design.

While the user signal transmitted from each MS to its serving BS and the DL control signal transmitted by each BS to its serving MS are not depicted in FIGS. 3 and 4 for convenience of understanding, those signals can be transmitted and received in the above process. In FIGS. 3 and 4, the sequence and the number of times the signals are transmitted and received between the MS and the BS can be changed variously within the scope of the present invention.

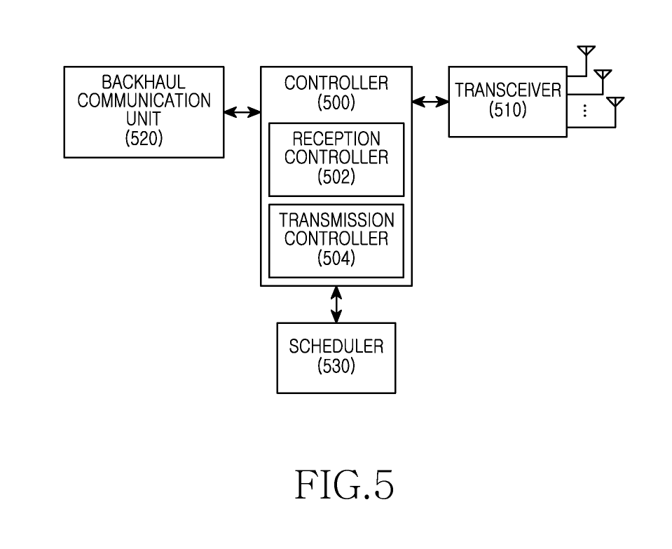

FIG. 5 is a block diagram of a BS in a wireless communication system according to an exemplary embodiment of the present invention.

Referring to FIG. 5, the BS includes a controller 500, a transceiver 510, a backhaul communication unit 520, and a scheduler 530. The controller 500 includes a reception controller 502 and a transmission controller 504.

The controller 500 controls and processes operations of the BS, and controls and processes to coordinate and communicate with the neighboring BS. More particularly, the controller 500 including the reception controller 502 and the transmission controller 504 controls to receive UL control signals of the serving MS and the neighboring MS, and controls and processes to transmit the user data signal to the serving MS and the neighboring MS.

More specifically, the controller 500, upon receiving the channel information from the serving MS, determines whether to apply a CoMP scheme to the serving MS. When determining to apply the CoMP scheme to the serving MS, the controller 500 controls and processes to exchange UL and DL resource allocation information of the serving MS and the information required to receive and process the UL control signal of the serving MS, with the neighboring BS. The controller 500 controls and processes to receive the UL control signal from the serving MS, and to receive the UL control signal of the neighboring MS based on the information exchanged with the neighboring BS. Based on the information obtained from the UL control signal of the serving MS and the UL control signal of the neighboring MS, the controller 500 controls and processes to transmit the signal to the serving MS or to transmit the signal to the serving MS and the neighboring MS according to a preset CoMP scheme. Herein, the UL control signal of the MS can include the channel information of the serving BS, the channel information of the neighboring BS, and ACK/NACK information of the previous DL user data. The channel information can include channel state information of every antenna combination, a channel quality indicator, a precoding matrix indicator, a rank indicator, an antenna codebook, an optimal antenna weight or code value of the serving BS, and an antenna weight or code value not to be selected by the neighboring BS. According to TDD, the channel information can include a sounding signal. The information required to receive and process the UL control signal from the MS includes the scrambling sequence of the signal, a hopping pattern, ID information of the BS and the MS, and MCS information.

The transceiver 510 transmits and receives the signals to and from every MS in the cell serviced by the BS, and receives and forwards the UL control signal of the neighboring MS to the controller 500 under the control of the controller 500.

The backhaul communication unit 520 transmits and receives signals to and from the neighboring BS over the backhaul. More particularly, under the control of the controller 500, the backhaul communication unit 520 transmits the resource allocation information of the serving MS and the information required to receive the UL control signal of the serving MS, to the neighboring BS, and receives the resource allocation information of the neighboring MS and the information required to receive the UL control signal of the neighboring MS, from the neighboring BS.

The scheduler 530 schedules all of the MSs in the cell serviced by the BS under the control of the controller 500. According to the CoMP application determined by the controller 500, the scheduler 530 can allocate the resource by varying a resource allocation priority of the corresponding MS. For example, the scheduler 530 can first allocate the resource to the CoMP applied MS, and allocate other resources to the CoMP non-applied MS. The scheduler 530 can allocate the resources by varying a priority of the corresponding MS per service. For example, the scheduler 530 can give high priority to the MS which uses a semi-persistent service or a circuit service such as Voice over Internet Protocol (VoIP) and thus first allocates the resource, and give low priority to the MS which uses a best effort service or a packet service such as data and thus allocates the resource. The scheduler 530 may allocate the resource by considering both of the CoMP application and the service type. For example, the scheduler 530 can give highest priority to the CoMP applied MS using the VoIP, give the second priority to the CoMP non-applied MS using the VoIP, give third priority to the CoMP applied MS using the data service, give lowest priority to the CoMP non-applied MS using the data service, and thus allocate the resources according to the priority. Also, the scheduler 530 can divide the whole resource region into a CoMP applied resource region and a CoMP non-applied resource region and thus allocate the divided resource regions according to the CoMP application of the MS. In so doing, relative sizes of the CoMP applied resource region and the CoMP non-applied resource region can be adaptively altered based on the channel state.

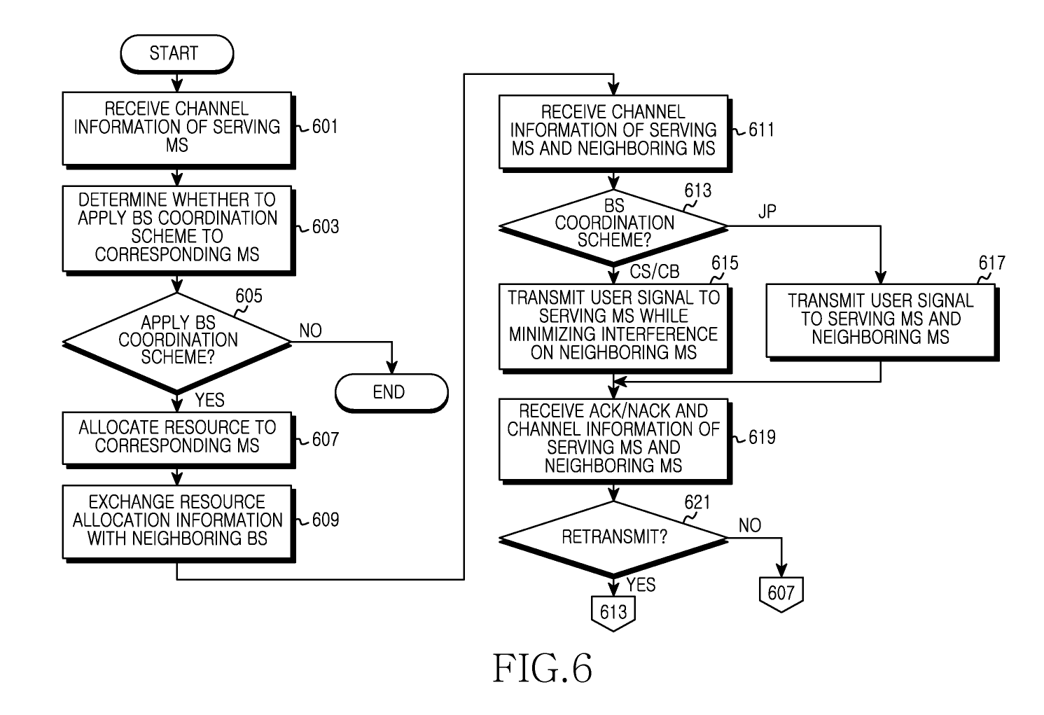

FIG. 6 illustrates operations of a BS in a wireless communication system according to an exemplary embodiment of the present invention.

Referring to FIG. 6, the BS receives channel information from a serving MS in step 601, and determines whether to apply the CoMP scheme for coordinating and communicating between the BSs with respect to the serving MS, based on the received channel information in step 603. Herein, the BS can determine based on the received channel information, whether the serving MS is the MS traveling in the cell boundary, and determine to apply the BS coordination when the serving MS travels in the cell boundary.

When the CoMP scheme is not applied to the serving MS in step 605, the BS finishes this process and operates in a manner according to the related art. When the CoMP scheme is applied to the serving MS, the BS allocates the resource to the corresponding MS in step 607 and exchanges the resource allocation information of the serving MS with the neighboring BS in step 609. That is, the BS transmits UL and DL resource allocation information of the CoMP applied serving MS and the information required to receive and process the UL control signal of the serving MS, to the neighboring BS via a backhaul, and receives the UL and DL resource allocation information of the neighboring MS and the information required to receive and process the UL control signal of the neighboring MS, from the neighboring BS via the backhaul.

In step 611, the BS receives the UL control signal of the serving MS and the UL control signal of the neighboring MS based on the information received from the neighboring BS at the same time.

In step 613, the BS verifies the type of preset CoMP scheme. When the preset CoMP scheme type is a CS/CB scheme, the BS minimizes the interference on the neighboring MS and transmits the user signal to the serving MS in step 615. For example, the BS can transmit the user data to the serving MS, and minimize the interference on the neighboring MS through the scheduling and beamforming control when the neighboring BS transmits the user data to the neighboring MS.

When the preset CoMP scheme type is a JP scheme, the BS transmits the user signal to the serving MS and the neighboring MS in step 617. For example, the BS can transmit the user data to the serving MS, and transmit the same user signal as the signal transmitted by the neighboring BS when the neighboring BS transmits the user data to the neighboring MS.

In step 619, the BS receives ACK and NACK information and the channel information from the serving MS and the neighboring MS. In so doing, when receiving the NACK information from the serving MS or the neighboring MS, the BS can retransmit the user data to the corresponding MS, or minimize the interference on the neighboring MS when the neighboring BS transmits the user data to the neighboring MS.

In step 621, the BS determines whether it is necessary to retransmit by receiving the NACK information. That is, upon receiving the NACK information, the BS determines the retransmission and returns to step 613 to repeat the subsequent steps according to the preset CoMP scheme. In contrast, upon receiving the ACK information, the BS determines no retransmission, returns to step 607 to allocate the resource to the MS, and then repeats the subsequent steps.

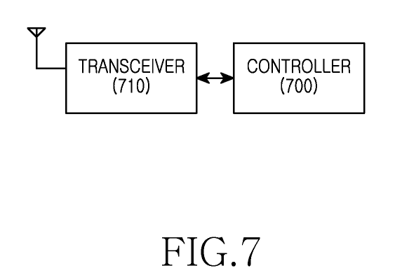

FIG. 7 is a block diagram of an MS in a wireless communication system according to an exemplary embodiment of the present invention.

Referring to FIG. 7, the MS includes a controller 700 and a transceiver 710.

The controller 700 controls and processes operations of the MS, and controls and processes to communicate according to a CoMP scheme transmission and reception scheme by which the neighboring cells coordinate and communicate. More particularly, the controller 700 controls and processes to transmit a control signal including channel information to the serving BS, and controls and processes to receive UL and DL resource allocation information for the CoMP scheme communication from the serving BS. The neighboring BS can receive the UL control signal transmitted from the MS to the serving BS because the serving BS of the MS and the neighboring BS exchange in advance the UL and DL resource allocation information of the MS and the information required to receive and process the UL control signal of the MS over a backhaul. Herein, the UL control signal of the MS can include the channel information of the serving BS, the channel information of the neighboring BS, and ACK/NACK information of a previous DL user data. At this time, the channel information can include channel state information of every antenna combination, a channel quality indicator, a precoding matrix indicator, a rank indicator, an antenna codeword, an optimal antenna weight or code value of the serving BS, and an antenna weight or code value not to be selected by the neighboring BS. According to TDD, the channel information can include the sounding signal. The information required to receive and process the UL control signal of the MS includes a scrambling sequence of the signal, a hopping pattern, ID information of the BS and the MS, and MCS information.

The transceiver 710 transmits and receives signals to and from the serving BS. Under the control of the controller 700, the transceiver 710 can transmit and receive signals to and from the neighboring BS.

In the wireless communication system, the serving BS transmits the resource allocation information of its MS to the neighboring BS, and the neighboring BS directly receives the control signal from the MS of the serving BS. Thus, since the delay as in the single cell is mitigated by removing the delay according to the backhaul, the CoMP scheme performance is enhanced and the CoMP scheme can be applied to not only a stationary MS but also a traveling MS. As the serving BS and the neighboring BS directly receive the ACK/NACK information from the MS, the CoMP scheme performance can be improved by promptly retransmitting the user data to be retransmitted as in the single cell. Since the retransmission is rapidly carried out in the single cell in case of the VoIP service which is sensitive to the delay, the CoMP scheme performance can be enhanced. Further, since each of the CoMP coordination BSs determines the algorithm for the CoMP coordination, additional network components are unnecessary, there are no delays according to the exchange of the algorithm calculation value, and the communication between the BS and the MS is not affected.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of a Base Station (BS) for inter-cell coordination in a wireless communication system, the method comprising:
receiving information of a neighboring Mobile Station (MS) from a neighboring BS;
receiving an UpLink (UL) control signal of the neighboring MS based on the received information of the neighboring MS; and
performing inter-cell coordination for the neighboring MS using the received UL control signal.

2. The method of claim 1, wherein the information of the neighboring MS comprises information required to receive and process the UL control signal of the neighboring MS, and at least one of UL resource allocation information of the neighboring MS, DownLink (DL) resource allocation information, a scrambling sequence of the signal, a hopping pattern, neighboring BS IDentifier (ID) information, neighboring MS ID information, and Modulation and Coding Scheme (MCS) information.

3. The method of claim 1, wherein the UL control signal of the neighboring MS comprises at least one of ACKnowledgement (ACK)/Negative ACKnowledgement (NACK) information, channel information of a serving BS of the neighboring MS, and channel information of all coordination BSs which perform the inter-cell coordination.

4. The method of claim 3, wherein the channel information comprises at least one of channel state information of every antenna combination, channel quality indicator information, precoding matrix indicator information, rank indicator information, antenna codeword information, an antenna weight or a code value of the serving BS, an antenna weight or a code value not to be selected by the coordination BS, and a sounding signal.

5. The method of claim 1, further comprising transmitting information of a serving MS of the BS to the neighboring BS over a backhaul.

6. The method of claim 5, wherein the performing of the inter-cell coordination for the neighboring MS comprises:
transmitting a user data signal to the serving MS,
wherein interference on the neighboring MS is minimized.

7. The method of claim 5, wherein the performing of the inter-cell coordination for the neighboring MS comprises:
transmitting a user data signal to the serving MS; and
transmitting a user data signal to the neighboring MS.

8. An apparatus of a Base Station (BS) for inter-cell coordination in a wireless communication system, the apparatus comprising:
a backhaul communication unit for receiving information of a neighboring Mobile Station (MS) from a neighboring BS;
a transceiver for receiving an UpLink (UL) control signal of the neighboring MS based on the received information of the neighboring MS; and
a controller for controlling to perform inter-cell coordination for the neighboring MS using the received UL control signal.

9. The apparatus of claim 8, wherein the information of the neighboring MS comprises information required to receive and process the UL control signal of the neighboring MS, and at least one of UL resource allocation information of the neighboring MS, DownLink (DL) resource allocation information, a scrambling sequence of the signal, a hopping pattern, neighboring BS IDentifier (ID) information, neighboring MS ID information, and Modulation and Coding Scheme (MCS) information.

10. The apparatus of claim 8, wherein the UL control signal of the neighboring MS comprises at least one of ACKnowledgement (ACK)/Negative ACKnowledgement (NACK) information, channel information of a serving BS of the neighboring MS, and channel information of all coordination BSs which perform the inter-cell coordination.

11. The apparatus of claim 10, wherein the channel information comprises at least one of channel state information of every antenna combination, channel quality indicator information, precoding matrix indicator information, rank indicator information, antenna codeword information, an antenna weight or a code value of the serving BS, an antenna weight or a code value not to be selected by the coordination BS, and a sounding signal.

12. The apparatus of claim 8, wherein the backhaul communication unit transmits information of a serving MS of the BS to the neighboring BS over a backhaul.

13. The apparatus of claim 12, wherein the controller controls the transceiver to transmit a user data signal to the serving MS, and controls to minimize interference on the neighboring MS.

14. The apparatus of claim 12, wherein the controller controls the transceiver to transmit a user data signal to the serving MS and to transmit a user data signal to the neighboring MS.

15. A method of a Mobile Station (MS) for inter-cell coordination in a wireless communication system, the method comprising:
receiving resource allocation information from a serving Base Station (BS); and
transmitting an UpLink (UL) control signal to the serving BS,
wherein the UL control signal is received by a neighboring BS according to information exchanged in advance by the serving BS and the neighboring BS over a backhaul.

16. The method of claim 15, wherein the information exchanged in advance by the serving BS and the neighboring BS over the backhaul comprises at least one of UL resource allocation information of the MS, DownLink (DL) resource allocation information, a scrambling sequence of the signal, a hopping pattern, neighboring BS ID information, neighboring MS ID information, and Modulation and Coding Scheme (MCS) information.

17. The method of claim 15, wherein the UL control signal comprises at least one of ACKnowledgement (ACK)/Negative ACKnowledgement (NACK) information, channel information of a serving BS of the neighboring MS, and channel information of all coordination BSs which perform the inter-cell coordination, and
the channel information comprises at least one of channel state information of every antenna combination, channel quality indicator information, precoding matrix indicator information, rank indicator information, antenna codeword information, an antenna weight or a code value of the serving BS, an antenna weight or a code value not to be selected by the coordination BS, and a sounding signal.

18. An apparatus of a Mobile Station (MS) for inter-cell coordination in a wireless communication system, the apparatus comprising:
a transceiver for transmitting and receiving signals; and
a controller for controlling the transceiver to receive resource allocation information from a serving Base Station (BS), and to transmit an UpLink (UL) control signal to the serving BS,
wherein the UL control signal is received by a neighboring BS according to information exchanged in advance by the serving BS and the neighboring BS over a backhaul.

19. The apparatus of claim 18, wherein the information exchanged in advance by the serving BS and the neighboring BS over the backhaul comprises at least one of UL resource allocation information of the MS, DownLink (DL) resource allocation information, a scrambling sequence of the signal, a hopping pattern, neighboring BS IDentifier (ID) information, neighboring MS ID information, and Modulation and Coding Scheme (MCS) information.

20. The apparatus of claim 18, wherein the UL control signal comprises at least one of ACKnowledgement (ACK)/Negative ACKnowledgement (NACK) information, channel information of a serving BS of the neighboring MS, and channel information of all of the coordination BSs which perform the inter-cell coordination, and
the channel information comprises at least one of channel state information of every antenna combination, channel quality indicator information, precoding matrix indicator information, rank indicator information, antenna codeword information, an antenna weight or a code value of the serving BS, an antenna weight or a code value not to be selected by the coordination BS, and a sounding signal.
